(19) United States
(12) Patent Application Publication
(10) Pub. No.: US 2020/0169570 A1
(43) Pub. Date: May 28, 2020

(54) SYSTEMS AND METHODS FOR DETECTING MALWARE INFECTIONS ASSOCIATED WITH DOMAIN GENERATION ALGORITHMS

(71) Applicant: CA, INC., SAN JOSE, CA (US)

(72) Inventor: Alexey Kleymenov, Dublin (IE)

(21) Appl. No.: 16/202,729

(22) Filed: Nov. 28, 2018

(51) Int. Cl. H04L 29/06; G06N 20/00; H04L 29/12; H04L 12/24

(52) U.S. Cl. CPC H04L 63/145; H04L 63/1416; H04L 41/145; G06N 20/00; H04L 61/1511; H04L 63/20

(57) ABSTRACT

The disclosed computer-implemented method for detecting malware infections associated with domain generation algorithms (DGAs) may include (i) receiving one or more domain names in a cluster of failed domain name system (DNS) requests and telemetry data from a client device, (ii) generating a classification model based on multiple unrelated features associated with the DGAs, (iii) performing an analysis of the failed DNS requests and the telemetry data by applying the classification model to identify domain names associated with malicious activity comprising utilization of the DGAs, based on the unrelated features, (iv) identifying the domain names associated with the malicious activity based on the analysis, and (v) performing a security action, based on the domain names, that protects against infection by malware associated with the malicious activity. Various other methods, systems, and computer-readable media are also disclosed.

### BACKGROUND

Increasingly, modern malware families (e.g., gozi, cidox, or upatre) rely on some form of domain generation algorithm (DGA) in order to complicate the detection and recovery procedures associated with malware, thereby prolonging malware infections on enterprise and consumer network computing systems. For example, malicious actors may utilize DGAs to generate previously unknown domain names that are difficult to proactively detect or sinkhole and which may consequently increase potential financial losses caused by downtime associated with malware infected systems.

Traditional DGA detection methods often utilize lexical and statistical models for detecting DGA generated domain names containing non-standard characters and/or nonsensical words or phrases. However, these traditional methods may fail to detect domain names generated by modern DGAs that are associated with malware but which are formed from English language wordlists and thus appear to be associated with legitimate computer processes.

### SUMMARY

As will be described in greater detail below, the instant disclosure describes various systems and methods for detecting malware infections associated with domain generation algorithms.

In one example, a computer-implemented method for detecting malware infections associated with domain generation algorithms (DGAs) may include (i) receiving one or more domain names in a cluster of failed domain name system (DNS) requests and telemetry data from a client device, (ii) generating a classification model based on a group of unrelated features associated with the DGAs, (iii) performing an analysis of the failed DNS requests and the telemetry data by applying the classification model to identify domain names associated with malicious activity including utilization of the DGAs, based on the unrelated features, (iv) identifying the domain names associated with the malicious activity based on the analysis, and (v) performing a security action, based on the domain names, that protects against infection by malware associated with the malicious activity.

In some examples, the classification model may be generated by (i) generating a statistical model including features associated with generic behavior patterns of DGAs (ii) generating a network model including features associated with a timing for failed DNS requests made by the DGAs, (iii) generating a lexical model including features associated with one or more n-grams, (iv) generating a local model including features associated with traffic generated from the client device, (v) generating a global model including features associated with entity-based patterns of domain generation algorithms, and (vi) generating a database query model (e.g., a WHOIS model) for querying features associated with known domain name data. In some embodiments, the features associated with the generic behavior patterns may include (i) a limited set of top level domains (TLDs) utilized by the DGAs, (ii) a distribution pattern of TLDs utilized in the DGAs, and/or (iii) a restricted number of domain levels utilized in a set of domains generated by the DGAs in a cluster.

In some examples, the features associated with the timing for the failed DNS requests may include (i) a continuous generation of non-repeating invalid domain names that ceases upon generating an existing domain name and/or (ii) a time gap between successive failed DNS requests that follows a detectable pattern. In some embodiments, the features associated with the traffic generated from the client device may include data identifying a parent process executing on the client device and/or other telemetry data on the client device. In other embodiments, the features associated with the entity-based patterns may include common patterns associated with DNS requests generated by large entities.

In some examples, the computer-implemented may further include (i) filtering potential false positives from an output of the classification model by whitelisting DNS request patterns determined to be non-malicious, (ii) adjusting the classification model based on the filtered output, and (iii) retraining the classification model based on at least one of feedback data and quality control activity. In some embodiments, the security action may include wherein the security module performs the security action by providing an alert to a malware threat protection service for protecting against malware threats on additional client devices in a network.

In some examples, the telemetry data may include (i) lexical data, (ii) statistical data, (iii) network data, (iv) local data, (v) global data, and (vi) domain name database (e.g., WHOIS) data. In some embodiment, the classification model may be a heuristic model or a machine-learning model.

In one embodiment, a system for detecting malware infections associated with domain generation algorithms (DGAs) may include at least one physical processor and physical memory that includes multiple modules and computer-executable instructions that, when executed by the physical processor, cause the physical processor to (i) receive, by a receiving module, one or more domain names in a cluster of failed domain name system (DNS) requests and telemetry data from a client device, (ii) generate, by a generating module, a classification model based on a group of unrelated features associated with the DGAs, (iii) perform, by an analysis module, an analysis of the failed DNS requests and the telemetry data by applying the classification model to identify domain names associated with malicious activity including utilization of the DGAs, based on the unrelated features, (iv) identify, by an identification module, the domain names associated with the malicious activity based on the analysis, and (v) perform, by a security module, a security action that protects against infection by malware associated with the malicious activity.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) receive one or more domain names in a cluster of failed domain name system (DNS) requests and telemetry data from a client device, (ii) generate a classification model based on a group of unrelated features associated with domain generation algorithms (DGAs), (iii) perform an analysis of the failed DNS requests and the telemetry data by applying the classification model to identify domain names associated with malicious activity including utilization of the DGAs, based on the unrelated features, (iv) identify the domain names associated with the malicious activity based on the analysis, and (v) perform a security action that protects against infection by malware associated with the malicious activity.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for detecting malware infections associated with domain generation algorithms.

FIG. 2 is a block diagram of an additional example system for detecting malware infections associated with domain generation algorithms.

FIG. 3 is a flow diagram of an example method for detecting malware infections associated with domain generation algorithms.

FIG. 4 is a block diagram of an example classification model for detecting malware infections associated with domain generation algorithms.

FIG. 5 is a flow diagram of an example method for filtering false positives from a detection of detecting malware infections associated with domain generation algorithms.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for detecting malware infections associated with domain generation algorithms (DGAs). As will be described in greater detail below, by generating a heuristic or machine learning classification model based on multiple unrelated features associated with domain generation algorithms such as generic behavior patterns, n-grams, the timing of failed DNS requests, client data traffic, global entity-based patterns, and WHOIS data, the systems and methods described herein may enable the detection of malware infections associated with domain names generated by DGAs and that are associated with malicious activity, network. By utilizing the classification model in this way, the systems and methods described herein may enable the detection of malware infections associated with DGAs that would otherwise be undetected by traditional methods relying solely on lexical or linguistic analyses.

Moreover, the systems and methods described herein may improve computing device security by protecting computing devices from being infected by malware attacks associated with malicious activity after detecting the presence of DGAs. In some examples, the systems and methods may provide DGA generated domain names to a malware threat protection service for subsequent identification and/or removal from a computing device.

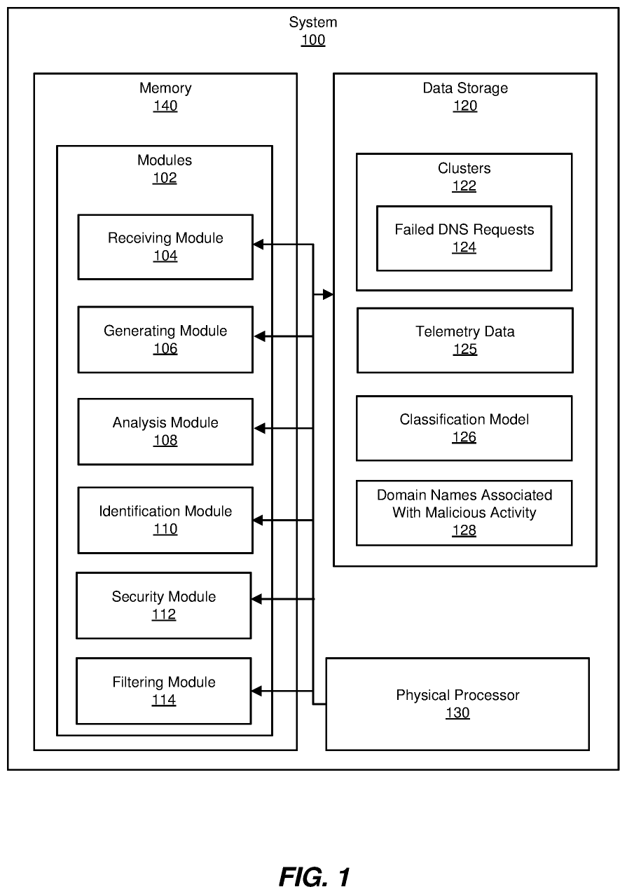

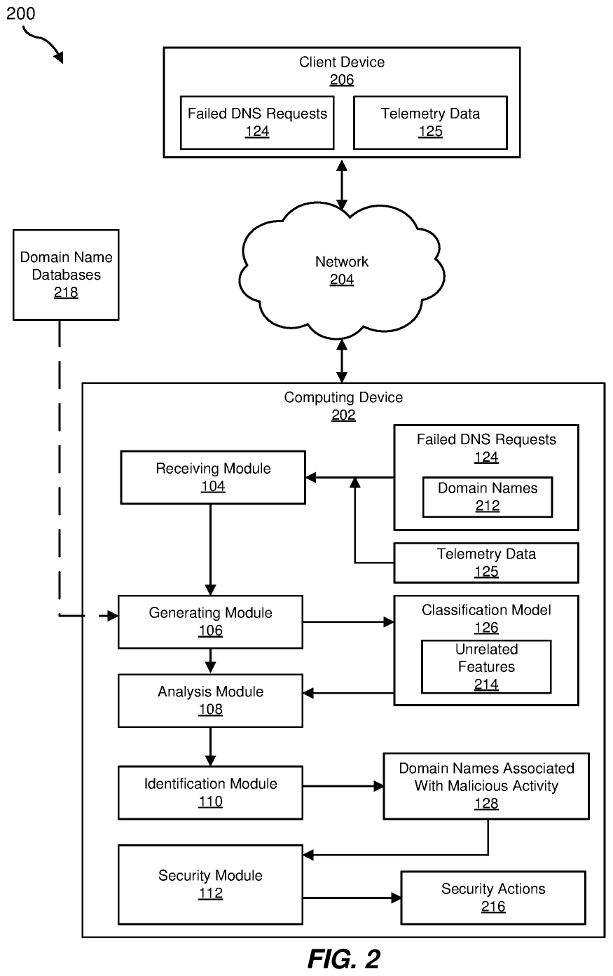

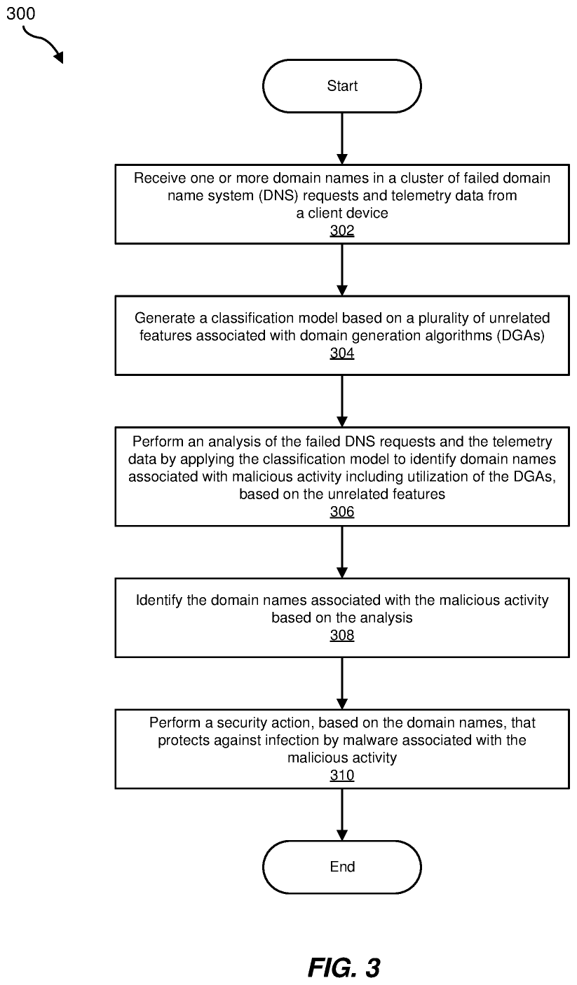

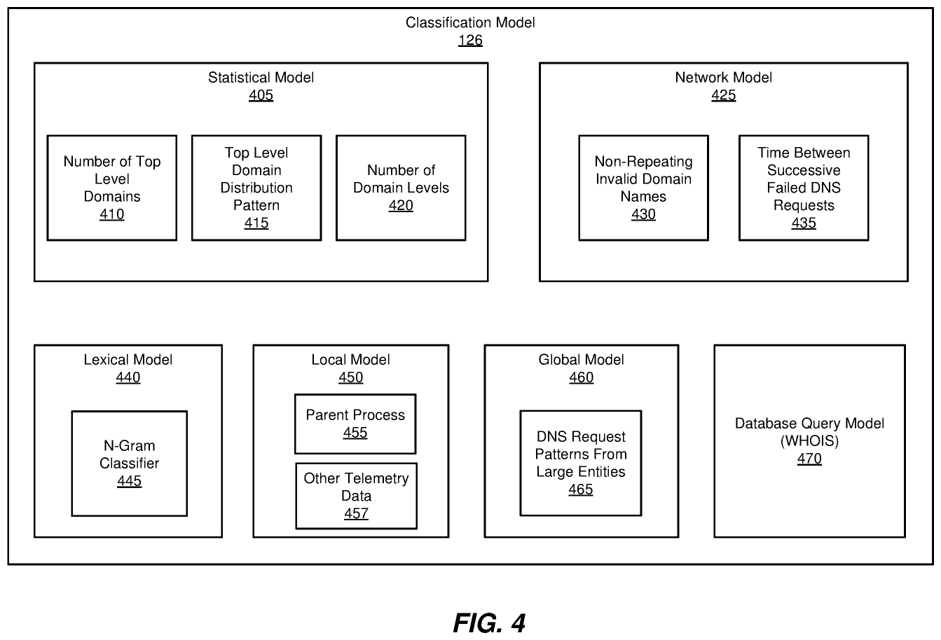

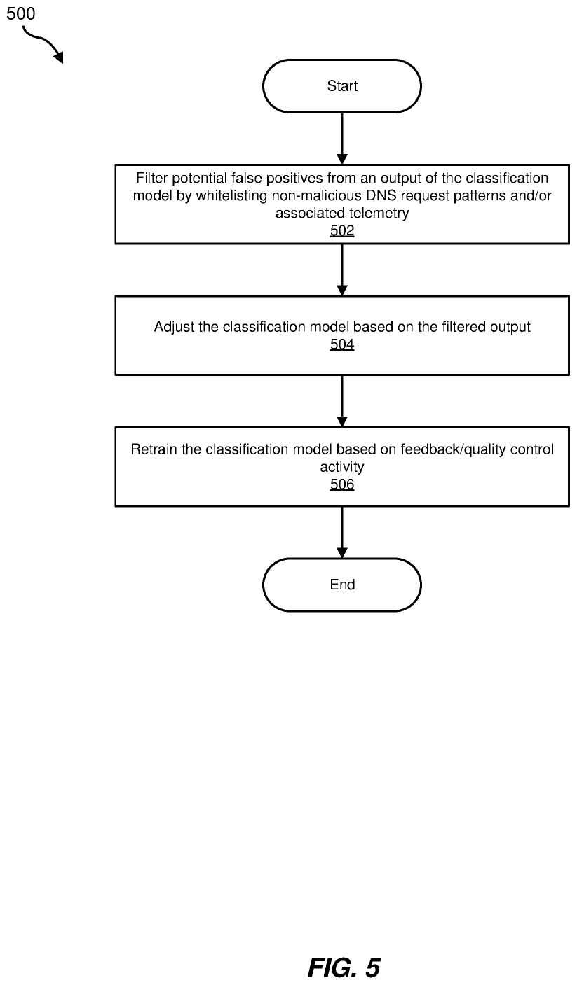

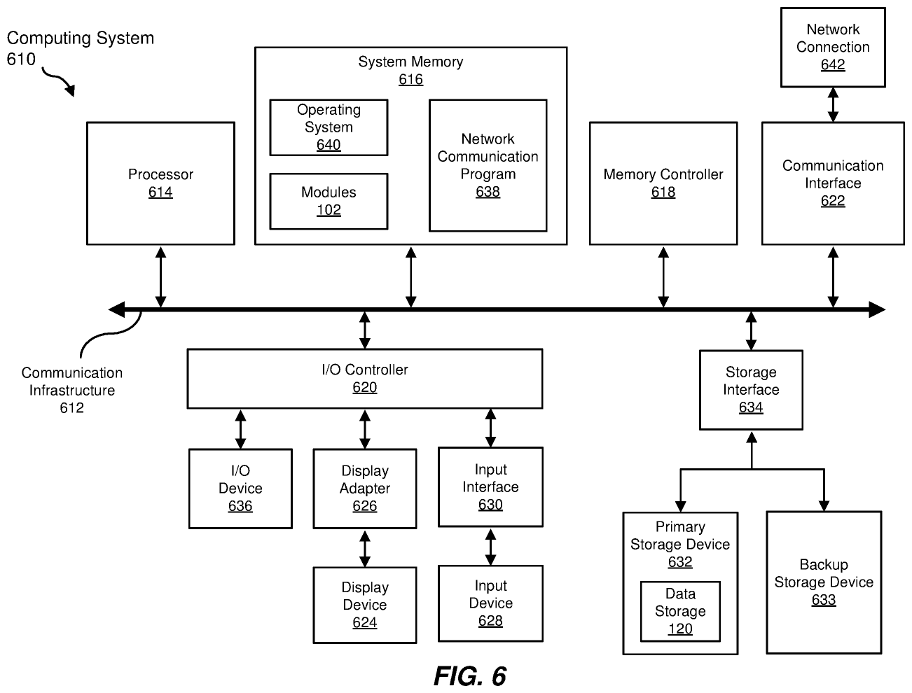

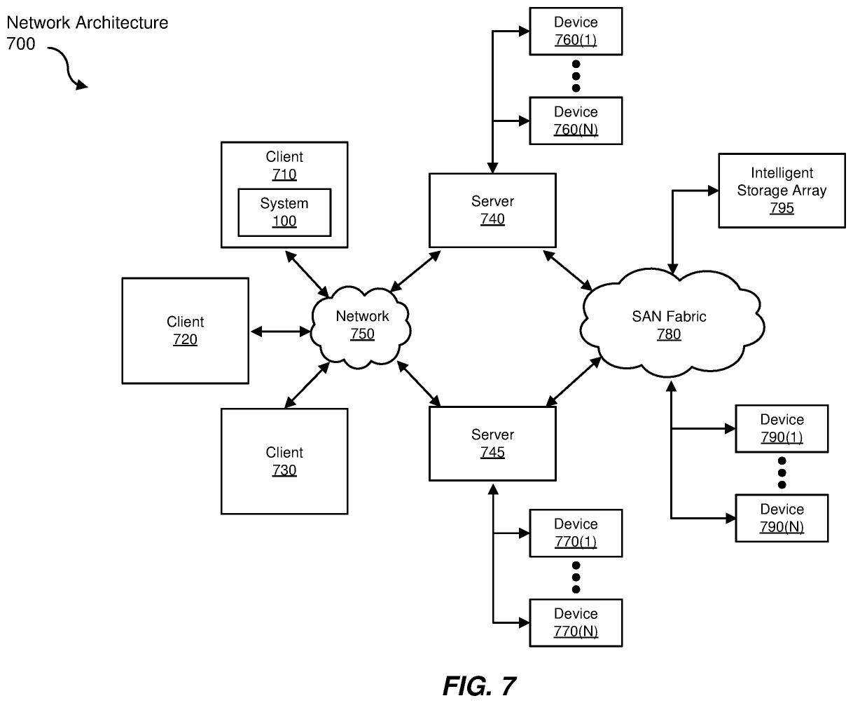

The following will provide, with reference to FIGS. 1-2, detailed descriptions of example systems for detecting malware infections associated with domain generation algorithms. Detailed descriptions of corresponding computer-implemented methods will also be provided in connection with FIGS. 3 and 5. A detailed description of an example classification model for detecting domain malware infections associated with domain generation algorithms will also be provided in connection with FIG. 4. In addition, detailed descriptions of an example computing system and network architecture capable of implementing one or more of the embodiments described herein will be provided in connection with FIGS. 6 and 7, respectively.

FIG. 1 is a block diagram of an example system 100 for detecting malware infections associated with domain generation algorithms. In certain embodiments, one or more of modules 102 in FIG. 1 may represent one or more software applications or programs that, when executed by a computing device, may cause the computing device to perform one or more tasks. For example, and as will be explained in greater detail below, example system 100 may include a receiving module 104 that receives one or more domain names in a cluster of failed DNS requests and telemetry data from a client device. Example system 100 may additionally include a generating module 106 that generates a classification model based on a group of unrelated features associated with DGAs. Example system 100 may also include an analysis module 108 that performs an analysis of the failed DNS requests and the telemetry data by applying the classification model to identify domain names associated with malicious activity including utilization of the DGAs, based on the unrelated features. Example system 100 may additionally include an identification module 110 that identifies the domain names associated with the malicious activity based on the analysis. Example system 100 may also include a security module 112 that performs a security action, based on the domain names, protecting against infection by malware associated with the malicious activity. Although illustrated as separate elements, one or more of modules 102 in FIG. 1 may represent portions of a single module or application.

For example, and as will be described in greater detail below, one or more of modules 102 may represent modules stored and configured to run on one or more computing devices, such as the devices illustrated in FIG. 2 (e.g., computing device 202). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate detecting malware infections associated with domain generation algorithms. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include a data storage 120 for storing data. In one example, data storage 120 may store one or more clusters 122 of failed DNS requests 124 sent over a network. Data storage 120 may also store telemetry data 125 and a classification model 126 for detecting domain names associated with malicious activity 128.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a client device 206 via a network 204. In one example, all or a portion of the functionality of modules 102 may be performed by computing device 202 and/or any other suitable computing system. As will be described in greater detail below, one or more of modules 102 from FIG. 1 may, when executed by at least one processor of computing device 202, enable computing device 202 to detect malware infections associated with DGAs.

For example, receiving module 104 may receive, from client device 206, failed DNS requests 124 including one or more domain names 212 and telemetry data 125. Next, generating module 106 may generate classification model 126 including unrelated features 214 (an optionally using data from domain name databases 218) associated with DGA behavior. Then, analysis module 108 may apply classification model 126 to analyze failed DNS requests 124 and telemetry data 125, based on unrelated features 214. Next, identification module 110 may identify domain names associated with malicious activity 128 (e.g., from among domain names 212) based on the analysis. Finally, security module 112 may perform one or more security actions 216, based on the domain names, protecting against infection by malware associated with the malicious activity.

Computing device 202 generally represents any type or form of computing device capable of reading computer-executable instructions. In some examples, computing device 202 may be a security server configured to detect malware infections on endpoint devices in a network. Additional examples of computing device 202 include, without limitation, application servers, web servers, storage servers, and/or database servers configured to run certain software applications and/or provide various security, web, storage, and/or database services. Although illustrated as a single entity in FIG. 2, computing device 202 may include and/or represent a plurality of servers that work and/or operate in conjunction with one another.

Client device 206 generally represents any type or form of computing device capable of reading computer-executable instructions. In some embodiments, client device 206 may represent an endpoint device capable of initiating multiple DNS requests for domain names and communicating telemetry data over network 204. Additional examples of client device 206 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Network 204 generally represents any medium or architecture capable of facilitating communication or data transfer. In one example, network 204 may facilitate communication between computing device 202 and client device 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for detecting malware infections associated with domain generation algorithms. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may receive one or more domain names in a cluster of failed DNS requests from a client device. For example, receiving module 104 may, as part of computing device 202 in FIG. 2, receive a group of domain names 212 in a cluster of failed DNS requests 124 and telemetry data 125 from client device 206. In some examples, failed DNS requests 124 may represent a cluster including multiple failed domain name server requests for domain names, sent from client device 206, to a domain name server. In some examples telemetry data 125 may include, without limitation, lexical data, statistical data, network data, local data, global data, and domain name database data (e.g., WHOIS data).

Receiving module 104 may receive failed DNS requests 124 and telemetry data 125 in a variety of ways. In some examples, receiving module 104 may request data describing a cluster (e.g., a cluster 122 shown in FIG. 1) of failed DNS requests 124 for one or more domain names previously sent to one or more domain name servers from client device 206. Receiving module 104 may also request telemetry data 125 from client device 206. Receiving module 104 may then receive failed DNS requests 124 and telemetry data 125 from client device 206 in response to the request.

At step 304, one or more of the systems described herein may generate a classification model based on a group of unrelated features associated with DGAs. For example, generating module 106 may, as part of computing device 202 in FIG. 2, generate classification model 126 based on unrelated features 214 associated DGAs.

The term “classification model,” as used herein, generally refers to a heuristic or machine learning based classifier that operates with features constructed based on clusters of failed DNS requests and telemetry data received from single entities (e.g., endpoint devices) as inputs and that are utilized for detecting malware infections associated with DGAs. In some examples, the classification model may be updated by tweaking the heuristic classifier and/or training (or retraining) the machine learning based classifier. As described herein, the classification model may be configured to identify domain names generated by DGAs that may be associated with malicious activity, based on evidence that a majority of DGAs utilized by malware authors typically generate a certain amount of non-repeating invalid domain names within a relatively short period of time until they reach ones that actually exist and belong to the malware authors.

The term “unrelated features,” as used herein, generally refers to any number or group of features associated with the generation of domain names by DGAs. For example, a group of unrelated features may include statistical data, lexical data, network timing data (e.g., timing data associated with failed DNS requests), data associated with a parent process generating network traffic and/or other telemetry data on a client device, global data describing large entity pattern-based behavior associated with domain name generation, and/or WHOIS data such as time-to-live (TTL) data, a number of associated IP addresses, domain name registrant information, and derived metadata such as a number of associated domains, their average TTL, etc.

The term “domain names associated with malicious activity,” as used herein, generally refers to domain names generated by DGAs according to known behavior utilized by malware authors. In some examples, malware may be configured to utilize DGAs that periodically generate large numbers of domain names on infected computing devices that may be used to communicate with malware command and control servers. The infected computing devices may then receive malware updates or commands utilizing the domain names.

Generating module 106 may generate classification model 126 in a variety of ways. In some examples, generating module 106 may be configured to generate a number of components, based on unrelated features 214, that are utilized by classification model 126. An example classification model 126 generated by generating module 106 is described in greater detail below with respect to FIG. 4.

Turning now to FIG. 4, classification model 126 may include a number of components including a statistical model 405, a network model 425, a lexical model 440, a local model 450, a global model 460 and a database query (e.g., WHOIS) model 470. Within classification model 126, statistical model 405 may be configured to generate features representing the differences between domain names associated with malicious activity and generic entries found in-the-wild. These differences may correspond to generic behavior patterns that malicious actors tend to follow when developing DGAs. The features may include, without limitation, a number of top-level domains (TLDs) 410, a TLD distribution pattern 415, and/or a number of domain levels 420. For example, the number of TLDs 410 may represent DGAs that only use a limited number or set of top-level domains (e.g., DGAs only using “.com” and “.net”) when generating domain names. TLD distribution pattern 415 may represent a distribution of TLDs used in DGAs that differ from corresponding values used generally over the Internet. Finally, number of domain levels 420 may represent a number of levels of all DGA domains in a cluster being the same. For example, DGAs may generate domain names in a cluster all of which have only 2 domain levels (e.g., “example.com”) or 3 domain levels (e.g., “news.example.com”).

In some examples, network model 425 may be based on network side information represented in the form of timing for failed DNS requests. Within classification model 126, network model 425 may be configured to identify certain properties or features that all DGAs generally need to implement to effectively achieve their goals. These properties or features may include, without limitation, non-repeating invalid (e.g., non-existing) domain names 430 and time between successive failed DNS requests 435. For example, non-repeating invalid domain names 430 may represent the large number of non-repeating domain names typically generated by DGAs until a successful one is identified, after which the generation of domain names halts. Time between successive failed DNS requests 435 may represent a time gap between DNS requests that follows a detectable pattern associated with DGAs as all non-existing domains are being processed and resolved at approximately equal periods of time.

In some examples, lexical model 440, which may include n-gram classifier 445, may be configured to check whether a domain name string matches letter distributions common for a particular language (e.g., English). In some examples, local model 450 may be based on local information received from entities (e.g., endpoint devices such as client device 206 in FIG. 1) generating traffic over a network. Within classification model 126, local model 450 may be configured to identify information or features associated with a parent process 455 generating traffic on an endpoint device. Additionally or alternatively, local model 450 may be configured to identify other telemetry data 457 including additional information about events occurring on an endpoint device around the same time and historical information describing the general behavior of the endpoint device, such as domains accessed and associated telemetry. For example, local model 450 may be access other telemetry data 457 to determine any domains comprising a cluster that were previously accessed by client device 206 (including when and how often the domains were accessed) as well as information describing what percentage of the cluster the previously accessed domains comprise.

In some examples, global model 460 may be based on global entity-oriented features associated with DNS request patterns common only for large entities such as organizations, industries or even countries but which may be uncommon for DNS request patterns associated with endpoint devices. Within classification model 126, global model 460 may be configured to identify information or features associated with large entity DNS request patterns 465.

Returning to FIG. 3, at step 306, one or more of the systems described herein may perform an analysis of the failed DNS requests and the telemetry data by applying the classification model to identify domain names associated with malicious activity including the utilization of DGAs, based on the unrelated features. For example, analysis module 108 may, as part of computing device 202 in FIG. 2, perform an analysis of failed DNS requests 124 and telemetry data 125 by applying classification model 126 to identify domain names associated with malicious activity 128, based on unrelated features 214.

Analysis module 108 may apply classification model 126 in a variety of ways. In some examples, analysis module 108 may apply a combination of the features in statistical model 405, network model 425, lexical model 440, local model 450, global model 460, and database query (e.g., WHOIS) model 470 to identify domain names associated with malicious activity 128.

At step 308, one or more of the systems described herein may identify domain names associated with malicious activity 128 based on the analysis performed at step 306. For example, identification module 110 may, as part of computing device 202 in FIG. 2, identify domain names associated with malicious activity 128 based on the analysis of failed DNS requests 124 and telemetry data 125 performed by applying classification model 126.

Identification module 110 may identify domain names associated with malicious activity 128 in a variety of ways. For example, from an output of classification model 126, identification module 110 may identify domain names associated with malicious activity 128 based on failed DNS requests 124 and/or telemetry data 125 conforming to behavior patterns associated with DGAs. In some embodiments, the behavior patterns may include data corresponding to a limited set of TLDs, a distribution of TLDs differing from corresponding values generally used over the Internet, consistent (e.g., 2 or 3) number of domain levels, the generation of a large number of non-repeating invalid/non-existing domain names, time gaps between requests following a detectable pattern, a parent process associated with generating the requests, other telemetry data (e.g., previous domains accessed by a client device and associated telemetry), DNS request patterns only associated with large entities, and WHOIS data.

At step 310, one or more of the systems described herein may perform a security action, based on the domain names associated with the malicious activity, that protects against infection by malware associated with malicious activity including the utilization of DGAs. For example, security module 112 may, as part of computing device 202 in FIG. 2, perform one or more security actions 216 protecting against DGAs generating domain names associated with malicious activity 128.

Security module 112 may be configured to perform a number of security actions 216 to protect against infection by malware. In some examples, security module 112 may provide an alert to a malware threat protection service for protecting against malware threats on client devices in a network. For example, security module 112 may generate an alert identifying domain names associated with malicious activity 128 as an indicator that client device 206 is compromised by malware responsible for their generation (e.g., the malware utilizes one or more DGAs that generated domain names associated with malicious activity 128).

FIG. 5 is a flow diagram of an example computer-implemented method 500 for filtering false positives from a detection of malware infections associated with DGAs. The steps shown in FIG. 5 may be performed by any suitable computer-executable code and/or computing system, including system 100 in FIG. 1, system 200 in FIG. 2, and/or variations or combinations of one or more of the same. In one example, each of the steps shown in FIG. 5 may represent an algorithm whose structure includes and/or is represented by multiple sub-steps, examples of which will be provided in greater detail below.

As illustrated in FIG. 5, at step 502 one or more of the systems described herein may filter potential false positives from a classification model output by whitelisting non-malicious DNS request patterns and/or associated telemetry. For example, filtering module 114 may, as part of computing device 202 in FIG. 2, filter potential false positives from classification model 126 by whitelisting non-malicious DNS request patterns and/or associated telemetry constantly appearing on multiple independent computing devices in a network, which are identified in failed DNS requests 124. In some examples, a whitelisting database may be built based on the potential false positives.

The term “false positive,” as used herein, generally refers to failed DNS requests that may exhibit behavior associated with the generation of domain names by DGAs, but which are in fact not. For example, multiple failed DNS requests associated with electronic mail mass mailings including one or more e-mail addresses associated with invalid domain names or multiple failed DNS requests made from a website (e.g., an advertising website) to multiple domains (one or more of which may be invalid) may appear to be DGAs generating large numbers of domain names but are in fact not associated with malicious activity involving the use of DGAs. For example, a non-malicious invalid domain name may be associated with an outdated e-mail address or a previously valid website address that is currently inactive (e.g., the website is down due to an outage or other problem).

Filtering module 114 may filter false positives in a variety of ways. In some examples, filtering module 114 may whitelist non-malicious DNS request patterns and/or associated telemetry generating invalid domain names.

At step 504, one or more of the systems described herein may adjust the classification model based on the filtered output. For example, filtering module 114 may, as part of computing device 202 in FIG. 2, adjust an output of classification model 126 based on the filtering (e.g., whitelisting) of non-malicious DNS request patterns performed at step 502.

Filtering module 114 may adjust the output of classification model 126 in a variety of ways. In some examples, filtering module 114 may utilize the non-malicious DNS request patterns and/or associated telemetry to train a heuristic or machine learning model representing classification model 126 to ignore failed DNS request patterns corresponding to non-malicious DNS request patterns generating invalid domain names.

At step 506, one or more of the systems described herein may retrain the classification model based on feedback/quality control activity. For example, filtering module 114 may, as part of computing device 202 in FIG. 2, retrain a heuristic or machine learning model representing classification model 126 based on feedback/quality control activity such as whitelisted non-malicious DNS request patterns and/or associated telemetry.

As explained in connection with method 300 above, the systems and methods described provide for detecting malware infections associated with DGAs. By applying a heuristic or machine learning based classifier model to a combination of unrelated types of telemetry and metadata, the model may be utilized to identify domain names associated with malicious activity with a high degree of precision as compared with conventional detection methods. The model may operate with features constructed based on clusters of failed DNS requests received from single entities (e.g., end user machines) as an input. The model may perform the clustering of DNS requests by grouping them according to timing and traffic origin. The model may rely on the fact that a majority of domain generation algorithms are designed to generate a certain amount of non-repeating invalid domain names within a relatively short period of time before reaching valid existing domain names belonging to malware authors. The base of the model may include a lexical model part based on statistical analysis, machine learning, or an n-gram classifier that functions to generate features representing differences between domain names generated by DGAs and generic entries found in-the-wild. The model may utilize statistical data powered by generic behavior patterns that malicious actors tend to follow when developing DGAs. The model may further utilize network side information represented in the form of timing properties for failed DNS requests known to be implemented by DGAs. The model may also utilize local side information from entities generating traffic under suspicion. The model may also use may utilize global entity-oriented features responsible for finding patterns common only for particular larger entries such as organizations, industries, or even countries. Finally, the model may use WHOIS and/or historical information including time-to-live (TTL) data, a number of associated IP addresses, domain name registrant information, and derived metadata such as a number of associated domains, their average TTL, etc. Additionally, the model may utilize various methods for filtering out false positives to further improve the detection results.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, data storage 120] from FIG. 1 may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the instant disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for detecting malware infections associated with domain generation algorithms.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for detecting malware infections associated with domain generation algorithms, at least a portion of the method being performed by a one or more computing devices comprising at least one processor, the method comprising:
receiving, by the one or more computing devices, one or more domain names in a cluster of failed domain name system (DNS) requests and telemetry data from a client device;
generating, by the one or more computing devices, a classification model based on a plurality of unrelated features associated with the domain generation algorithms (DGAs);
performing, by the one or more computing devices, an analysis of the failed DNS requests and the telemetry data by applying the classification model to identify domain names associated with malicious activity comprising utilization of the DGAs, based on the unrelated features;
identifying, by the one or more computing devices, the domain names associated with the malicious activity based on the analysis; and
performing, by the one or more computing devices, a security action, based on the domain names, that protects against infection by malware associated with the malicious activity.

2. The computer-implemented method of claim 1, wherein generating the classification model comprises:
generating a statistical model comprising features associated with generic behavior patterns of DGAs;
generating a network model comprising features associated with a timing for failed DNS requests made by the DGAs;
generating a lexical model comprising features associated with one or more n-grams;
generating a local model comprising features associated with traffic generated from the client device;
generating a global model comprising features associated with entity-based DNS request patterns; and
generating a database query model for querying features associated with known domain name data.

3. The computer-implemented method of claim 2, wherein the features associated with the generic behavior patterns comprise at least one of:
a limited set of top level domains (TLDs) utilized by the DGAs;
a distribution pattern of TLDs utilized in the DGAs; and
a restricted number of domain levels utilized in a set of domains generated by the DGAs in a cluster.

4. The computer-implemented method of claim 2, wherein the features associated with the timing for the failed DNS requests comprise at least one of:
a continuous generation of non-repeating invalid domain names that ceases upon generating an existing domain name; and
a time gap between successive failed DNS requests that follows a detectable pattern.

5. The computer-implemented method of claim 2, wherein the features associated with the traffic generated from the client device comprise data identifying at least one of:
a parent process executing on the client device; and
other telemetry data on the client device.

6. The computer-implemented method of claim 2, wherein the features associated with the entity-based patterns comprise common patterns associated with DNS requests generated by large entities.

7. The computer-implemented method of claim 1, further comprising:
filtering potential false positives from an output of the classification model by whitelisting DNS request patterns determined to be non-malicious;
adjusting the classification model based on the filtered output; and
retraining the classification model based on at least one of feedback data and quality control activity.

8. The computer-implemented method of claim 1, wherein performing the security action comprises providing an alert to a malware threat protection service for protecting against malware threats on additional client devices in a network.

9. The computer-implemented method of claim 1, wherein the telemetry data comprises:
lexical data;
statistical data;
network data;
local data;
global data; and
domain name database data.

10. The computer-implemented method of claim 1, wherein the classification model comprises at least one of a heuristic and a machine-learning model.

11. A system for enabling multi-factor authentication for protecting against malware infections associated with domain generation algorithms, the system comprising:
at least one physical processor;
physical memory comprising a plurality of modules and computer-executable instructions that, when executed by the physical processor, cause the physical processor to:
receive, by a receiving module, one or more domain names in a cluster of failed domain name system (DNS) requests and telemetry data from a client device;
generate, by a generating module, a classification model based on a plurality of unrelated features associated with the domain generation algorithms (DGAS);
perform, by an analysis module, an analysis of the failed DNS requests and the telemetry data by applying the classification model to domain names associated with malicious activity comprising utilization of the DGAs, based on the unrelated features;
identify, by an identification module, the domain names associated with the malicious activity based on the analysis; and
perform, by a security module, a security action, based on the domain names, that protects against infection by malware associated with the malicious activity.

12. The system of claim 11, wherein the generating module generates the classification model by:
generating a statistical model comprising features associated with generic behavior patterns of the DGAs;
generating a network model comprising features associated with a timing for failed DNS requests made by the DGAs;
generating a lexical model comprising features associated with one or more n-grams;
generating a local model comprising features associated with traffic generated from the client device;
generating a global model comprising features associated with entity-based patterns of the DGAs; and
generating a database query model for querying features associated with known domain name data.

13. The system of claim 12, wherein the features associated with the generic behavior patterns comprise at least one of:
a limited set of top level domains (TLDs) utilized by the DGAs;
a distribution pattern of TLDs utilized in the DGAs; and
a restricted number of domain levels utilized in a set of domains generated by the DGAS in a cluster.

14. The system of claim 12, wherein the features associated with the timing for the failed DNS requests comprise at least one of:
a continuous generation of non-repeating invalid domain names that ceases upon generating an existing domain name; and
a time gap between successive failed DNS requests that follows a detectable pattern.

15. The system of claim 12, wherein the features associated with the traffic generated from the client device comprise data identifying at least one of:
a parent process executing on the client device; and
other telemetry data on the client device.

16. The system of claim 12, wherein the features associated with the entity-based patterns comprise common patterns associated with DNS requests generated by large entities.

17. The system of claim 11, further comprising a filtering module that causes the physical processor to:
filter potential false positives from an output of the classification model by whitelisting DNS request patterns determined to be non-malicious;
adjust the classification model based on the filtered output; and
retrain the classification model based on at least one of feedback data and quality control activity.

18. The system of claim 11, wherein the security module performs the security action by providing an alert to a malware threat protection service for protecting against malware threats on additional client devices in a network.

19. The system of claim 11, wherein the telemetry data comprises:
lexical data;
statistical data;
network data;
local data;
global data; and
domain name database data.

20. A non-transitory computer-readable medium comprising one or more computer-executable instructions that, when executed by at least one processor of a computing device, cause the computing device to:
receive one or more domain names in a cluster of failed domain name system (DNS) requests and telemetry data from a client device;
generate a classification model based on a plurality of unrelated features associated with domain generation algorithms (DGAs);
perform an analysis of the failed DNS requests and the telemetry data by applying the classification model to identify domain names associated with malicious activity comprising utilization of the DGAs, based on the unrelated features;
identify the domain names associated with the malicious activity based on the analysis; and
perform a security action, based on the domain names, that protects against infection by malware associated with the malicious activity.
